(19) United States
(12) Patent Application Publication
(10) Pub. No.: US 2025/0224271 A1
(43) Pub. Date: Jul. 10, 2025

(54) APPARATUS FOR LOCATION-BASED ILLUMINANCE SENSING AND RECORDING AND SYSTEMS INCLUDING THE SAME

(71) Applicant: IMEG Consultants Corp., Rock Island, IL (US)

(72) Inventors: Shanna L. Olson, Cudahy, WI (US); Sam W. Rall, Chicago, IL (US)

(21) Appl. No.: 18/999,653

(22) Filed: Dec. 23, 2024

Related U.S. Application Data
(60) Provisional application No. 63/618,416, filed on Jan. 8, 2024.

(51) Int. Cl. G01J 1/02; G01J 1/04; G01J 1/42; G01J 1/44

(52) U.S. Cl. CPC G01J 1/0266; G01J 1/0271; G01J 1/0403; G01J 1/4204; G01J 1/44

(57) ABSTRACT

Described herein is an apparatus for location-based illuminance sensing and recording. The apparatus includes a rod having a first, top end, a second, bottom end, and a body extending between the first end and the second end. The apparatus also includes a base coupled to the second, bottom end of the rod, the base including a housing retaining a location sensor and an illuminance sensor configured to locally capture location measurements and illuminance measurements, respectively. An illuminance mapping system including the apparatus and a control device communicatively coupled to the apparatus is also described herein, as are methods of operating the apparatus and system.

### CROSS-REFERENCE TO RELATED APPLICATIONS

This application claims the benefit of priority to U.S. Provisional Patent Application No. 63/618,416, filed Jan. 8, 2024, the entire contents of which are incorporated by reference herein.

### FIELD

This disclosure is directed to illuminance sensing and, more particularly, to an apparatus for location-based illuminance sensing and recording, and systems and methods involving such an apparatus.

### BACKGROUND

Many buildings and other properties benefit from exterior lighting design, in which the level of light surrounding the property (e.g., throughout a parking lot, within a stadium, etc.) is specifically selected, including the particular light fixtures chosen, where to install them, and how they illuminate the space around them. Light fixture performance and cost-effectiveness has advanced significantly over the course of modern lighting installations and thus has created a demand for updating under-performing or obsolete designs. In some instances, under-performing or damaged lighting can be a nuisance, but in the case of exterior lighting, the lighting design is related to the safety and peace of mind for the people using the space.

To assess the condition of existing lighting designs, conventionally, a survey is conducted by a surveyor after sunset. Light fixture performance can be assessed with a variety of measurements, such as illuminance. Illuminance characterizes how well a fixture is lighting a surface, such as the ground or the side of a building. The metric units for illuminance are lux, and illuminance is measured with specialized instruments that can vary in accuracy, consistency, robustness, size, and ease-of-use. The cost of the instruments generally increases with the level of sophistication, sometimes exceeding $3,000 (USD).

Conducting illuminance surveys conventionally includes the surveyor measuring points throughout the environment or area of interest, and these points may be as frequent as every two feet across the area. In the case of a large parking lot, for example, the surveyor sets an illuminance meter at grade (that is, on the ground surface), aligns their body such that they are not blocking the light being measured at the meter, and captures an illuminance reading by pressing a button on the meter. The surveyor then approximates the location of the reading relative to a large map or drawing of the area of interest. Surveying one area of interest can be time-consuming, taking one to six or more hours, and often involves capturing measurements at points of interest in excess of hundreds. The exact location of the individual points is critical to develop an aggregate assessment of the illuminance of a surface using such point measurements. Once the site survey is complete, the surveyor transfers the hand markups from the paper map to an electronic site plan. During this digitization process, once again, personnel must estimate the approximate location at which an illuminance reading was captured. The resulting document may include a mapped site plan with numerically annotated illuminance readings throughout.

It follows that placing a sophisticated instrument on the ground many times and manually logging each point's exact location, relative to a paper site map, results in a workflow that is relatively cumbersome, time-consuming, and complex. Typically, the project site is still being used during the survey, and vehicle traffic may still travel throughout the project site, which can create potential safety hazards for the surveyor. While the surveyor is bending down to place or relocate the illuminance meter, they have a limited view of any vehicular traffic, and, likewise, vehicle drivers may be less able to see the surveyor in this bent position. Additionally, picking up and placing an instrument on the ground several hundred times over the course of the survey poses potential ergonomic health risks to the surveyor.

Some systems include electronic GPS measuring devices, which can present a partial solution to the conventional method of surveying. However, the accuracy required for such a survey typically exceeds the specifications of conventional consumer electronic products, such as a smartphone, which may only have an accuracy of about ten feet from their internal GPS sensors. More sophisticated Geographic Information System (GIS) instruments have been developed that can achieve the desired one-foot accuracy, but these instruments are generally cost prohibitive and/or too large to be easily used by a single surveyor, while at the same time taking illuminance readings with a separate meter.

Accordingly, a need exists for an illuminance measuring system that is efficiently sized, cost effective, and usable by a single surveyor to conduct an illuminance survey safely and quickly, relative to existing systems, and that can automatically populate an electronic map of the area of interest with captured illuminance readings, for more accurate, relatable, and visually impactful documentation.

### BRIEF DESCRIPTION OF THE DISCLOSURE

In one aspect, an apparatus for location-based illuminance sensing and recording is provided. The apparatus includes a rod having a first, top end, a second, bottom end, and a body extending between the first end and the second end. A base is coupled to the second, bottom end of the rod, the base including a housing retaining a location sensor and an illuminance sensor configured to locally capture location measurements and illuminance measurements, respectively.

In another aspect, an illuminance mapping system is provided. The illuminance mapping system includes an apparatus for location-based illuminance sensing and recording and a control device communicatively coupled to the apparatus. The apparatus includes a rod having a first, top end, a second, bottom end, and a body extending between the first end and the second end. A base is coupled to the second, bottom end of the rod, the base including a housing retaining a location sensor and an illuminance sensor configured to locally capture location measurements and illuminance measurements, respectively. The control device is configured to activate the illuminance sensor and the location sensor.

In a further aspect, a method of location-based illuminance sensing is disclosed. The method includes providing an apparatus for location-based illuminance sensing and recording. The apparatus includes a rod having a first, top end, a second, bottom end, and a body extending between the first end and the second end. A base is coupled to the second, bottom end of the rod, the base including a housing retaining a location sensor and an illuminance sensor configured to locally capture location measurements and illuminance measurements, respectively. The method also includes operating a control device communicatively coupled to the apparatus to generate a control signal that causes the location sensor and the illuminance sensor to capture respective sensed values.

### BRIEF DESCRIPTION OF THE DRAWINGS

FIG. 1 is a simplified view of an apparatus for location-based illuminance sensing and recording, according to the present disclosure.

FIG. 2 is a perspective view of a base of the apparatus shown in FIG. 1.

FIG. 3 is a simplified schematic diagram of one embodiment of the apparatus shown in FIG. 1 in communication with a control device.

FIGS. 4-6 depict example illuminance maps generated using sensed values generated by the apparatus shown in FIG. 1.

### DETAILED DESCRIPTION OF THE DISCLOSURE

The present disclosure is directed to an apparatus for location-based illuminance sensing and recording and systems including such an apparatus. Embodiments of the apparatus described herein include a vertical rod having a first, top end and a second, bottom end. A body of the rod extends between the first and second ends thereof. In some example embodiments, an optional accessory, such as an imaging device (e.g., a camera), is coupled to the first, top end of the rod, and a base is coupled to the second, bottom end. The base includes a housing that retains therein a position or location sensor and an illuminance sensor. The housing may also retain, for example, a power source (e.g., a battery), a processing or computing device, a memory device, and a communication interface (e.g., a wireless communication interface, such as a BLUETOOTH communication interface). A control device is operable to control operation of the sensor(s) (and, where applicable, the imaging device or other optional accessory). In some embodiments, the control device is a handheld computing device, such as a smartphone or tablet. In some embodiments, the control device is coupled to the apparatus at a location between the first and second ends, at a height that is approximately “waist high,” as described further herein. For example, the rod may include a dock for retaining the control device. Alternatively, the control device may be integrated with the apparatus and may be a dedicated control device for the control of the apparatus.

In the example embodiment, a user operates the control device to generate a control signal that causes the location sensor and illuminance sensor to simultaneously capture respective sensed values—that is, the location sensor captures a sensed position value, and the illuminance sensor simultaneously captures a sensed illuminance value. Specifically, the user operates the control device to generate the control signal while the rod is in a generally vertical orientation. In this way, the user can capture sensed values using the apparatus, without needing to bend down. For instance, the operator is holding the control device or is operating the control device while it is coupled to the apparatus at a comfortable, ergonomic position (e.g., at waist height). Moreover, because the position value and the illuminance value are captured at the same time and from the same location (that is, the base of the apparatus), the accuracy and precision of the position and illuminance measurements are improved. Accordingly, the apparatus is a standalone solution for illuminance mapping, in which all measurements are locally captured, such that no internet connection or communication with remote devices is required during the surveying process. Additionally, in some example embodiments, the control signal also causes an imaging device at the top of the rod to capture one or more images of a region surrounding the rod. This image data can be used to improve the resulting survey documentation, as described further herein. Other accessories coupled to the rod may be operated using the control device, for example, in response to the control signal.

In the example embodiment, the apparatus is portable, such that it can be maneuvered and operated by a single person throughout an area of interest. Where the control device is couplable to the rod, the height of the control device or the dock thereof is adjustable. Additionally, the location sensor is advantageously a location sensor accurate within about one foot or 12 inches (in), such as a high-precision GPS sensor. In one embodiment, the GPS sensor includes a GPS receiver retained in the base, as well as a GPS antenna. The GPS sensor may be a single sensor including both the GPS receiver and antenna, or the antenna may be spaced from and communicatively coupled to the receiver. In the example embodiment, the captured sensed values are transmitted, via the communication interface, to the control device, at which the sensed values are stored and/or displayed. The sensed values may additionally be stored locally at the apparatus (e.g., at the memory device).

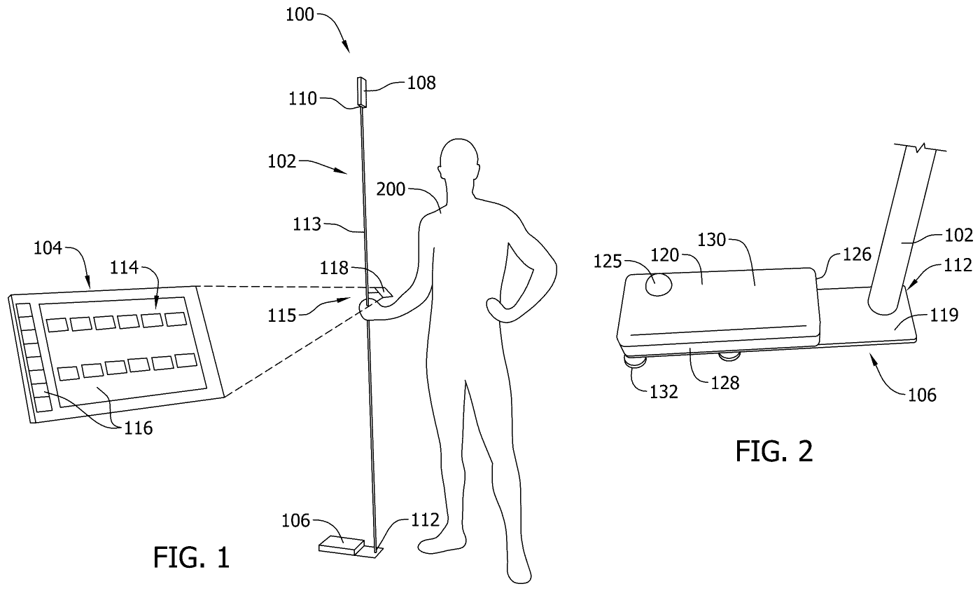

Additional features, aspects, variations, and improvements of the apparatus are described herein, with respect to the Figures of the present application. In particular, FIG. 1 illustrates an example embodiment of an apparatus 100 according to the present disclosure. Apparatus 100 includes a rod 102, a base 106, and an optional accessory 108, such as an imaging device 108. Rod 102, which may also be referred to as a pole, has a first end 110 and a second end 112. A body 113 of rod 102 extends from first end 110 to second end 112. As rod 102 is generally vertically oriented during operation of apparatus 100, first end 110 is referred to a top end of rod 102, and second end 112 is referred to as a bottom end of rod 102. Imaging device 108 is coupled to first, top end 110 of rod 102, and base 106 is coupled to second, bottom end 112 of rod 102. Rod 102 has a length defined between top end 110 and bottom end 112 thereof. The length of rod 102 is between about 36 in. and 80 in. and may be adjustable or variable.

A user 200 operates apparatus 100 while rod 102 is generally vertically oriented, as depicted in FIG. 1. In particular, user 200 operates a control device 104 that is communicatively coupled to apparatus 100 to activate the various sensors and functions of apparatus 100. Control device 104 may be separate from rod 102 and operated as a separate handheld device, such as a smartphone or tablet device. Additionally or alternatively, control device 104 is couplable to rod 102. In some embodiments, apparatus 100 includes a dock 118 coupled to rod body 113 at an intermediate location 115 between top end 110 and bottom end 112. Control device 104 is removably couplable to rod 102 via dock 118. In such embodiments, dock 118 for control device 104 is located at intermediate location 115 that is waist high relative to a user 200 of apparatus 100. Therefore, the height of intermediate location 115 may be between about 24 in and 48 in and may be adjustable or variable. In some embodiments, control device 104 is integrated with rod 102 and is not removable from dock 118.

In the example embodiment, user 200 does not need to bend over to operate apparatus 100, improving the ergonomics of illuminance capture over at least some known devices. For example, user 200 operates control device 104 as a handheld device and can hold control device 104 in any position that is comfortable and accessible for user 200. As another example, where control device 104 is coupled to rod 102 via dock 118, dock 118 may be positioned at a comfortable, ergonomic height, for operation of apparatus 100.

In some embodiments, the overall length of rod 102 is adjustable. For example, rod 102 may include two or more pieces telescopically coupled together. In this way, rod 102 may be adjustable and additionally/alternatively may be collapsible to a much smaller size (e.g., to about 12 inches or less). In some embodiments, rod 102 is foldable or includes two or more pieces removably coupled together (e.g., via a threaded connection, via a friction fit, via a ball and detente connection, etc.), or is otherwise able to be collapsed or reduced in size, for example, for travel. Rod 102 may be formed from any suitable material(s), including, but not limited to, metal or plastic. In some embodiments, control device 104, base 106, and/or imaging device 108 are removably coupled to rod 102, such that apparatus 100 can be deconstructed when not in use.

Broadly, user 200 interacts with control device 104 to control apparatus 100 to capture sensed position and illuminance values. In this way, user 200 does not need to bend down to capture illuminance and position measurements on grade, improving the ergonomics of apparatus 100 over at least some known devices. Control device 104 may include one or more control mechanisms 116, which may be embodied as virtual control mechanisms within a dedicated software application executed on control device 104 and displayed on a display 114 of control device 104, as described further herein. In the example embodiment, control device 104 includes a computing device that is independently operable from apparatus 100. For example, control device 104 may be embodied as a user computer device, such as a tablet, smartphone, etc. In some embodiments, apparatus 100 includes control mechanisms, such as physical control mechanisms 116, that are integral to apparatus 100 (e.g., as one or more buttons or switches on rod 102, such as on dock 118.

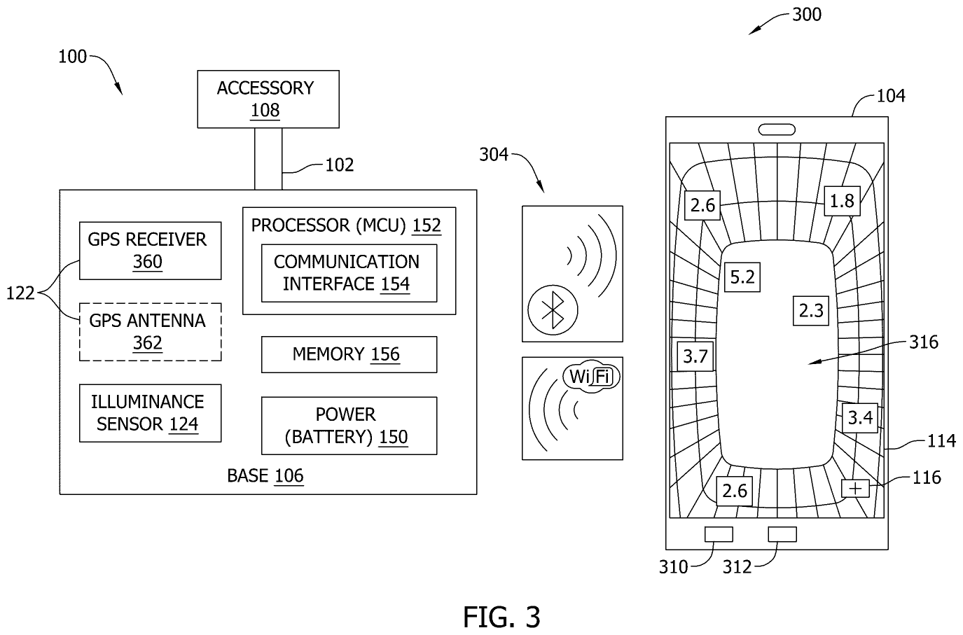

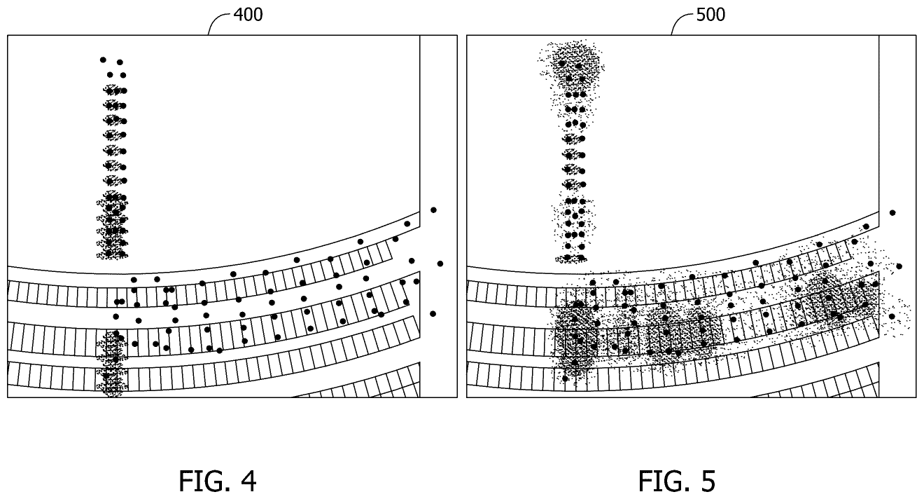

With reference to FIG. 2, base 106 includes a base plate 119 and housing 120, which retains various operational components of apparatus 100. Base plate 119 is coupled to second, bottom end 112 of rod 102. In some embodiments, base plate 119 is fixedly coupled to rod 102, such as via welding. In some embodiments, base plate 119 is removably coupled to rod 102, such as via a threaded connection or any other suitable connection method. Housing 120 retains therein at least a location sensor 122 and an illuminance sensor 124 (see FIG. 3). In the example embodiment, housing 120 also retains the necessary computing elements to enable the functionality of apparatus 100 described herein, such as a processing device (e.g., a microprocessor) and a memory device, which may be embodied in one or more PCBs which may in turn be co-located with one or more of location sensor 122 and/or illuminance sensor 124.

Housing 120 includes a side wall 126, a bottom wall 128, and a top wall 130, which collectively define a cavity (not shown) therebetween, for housing the operational components of apparatus 100. In some embodiments, bottom wall 128 and/or top wall 130 is removably coupled to side wall 126, such that housing 120 can be opened to access the components therein. In some embodiments, top wall 130 includes one or more connection features (not specifically shown) that enable coupling housing 120 to rod 102 and/or to base plate 119, such as a threaded connection feature, a snap-fit connection feature, and the like. In some embodiments, top wall 130 is transparent or includes one more openings therein, at which illuminance sensor 124 captures illuminance measurements. For example, illuminance sensor 124 is coupled to top wall 130 and has an optical sensing component 125 thereof positioned in an opening (not shown) in top wall 130.

In some embodiments, base 106 also includes one or more feet 132 coupled to a bottom (ground-facing) surface of bottom wall 128. Feet 132 are a protective feature configured to prevent damage to bottom wall 128 during repeated contact with the ground. Alternative protective feature(s) may include ridges, protrusions, or a sheet of material coupled to bottom wall 128. Feet 132 and/or other feature(s) may be formed from, for example, plastic, metal, rubber, foam, and/or any other material.

Housing 120 has any suitable dimensions such that apparatus 100 can be free-standing during operation thereof. Accordingly, in the example embodiment, housing 120 has a width of between 3 inches and 12 inches. Housing 120 also has a height or depth suitable to retain the operational components of apparatus 100 therein. Accordingly, in the example embodiment, the height of housing 120 is between 1 inch and 6 inches. In some embodiments, housing 120 is square or rectangular. In other embodiments, housing 120 is cylindrical in shape, such that the width of housing 120 corresponds to a diameter thereof or has any other regular or irregular shape that enables housing 120 to function as described herein. Housing 120 may be formed from any suitable material(s), including, but not limited to, metal or plastic.

In accordance with the present disclosure, apparatus 100 is a single device that is portable enough to be carried and operated by one person (e.g., user 200). As detailed herein, apparatus 100 includes a sophisticated illuminance sensor (e.g., illuminance sensor 124) housed in a robust enclosure (e.g., housing 120) that is attached to a pole (e.g., rod 102), such that apparatus 100 can be picked up and put back down without user 200 having to bend at the waist. This design also enables user 200 to keep their attention and vision on their surroundings, facilitating improving safety. An electronic GIS instrument (e.g., location sensor 122) with a one-foot accuracy is also attached to the pole and thus enhances the portability of the entire solution on one device. With both instruments attached to a single, ergonomic apparatus 100, their respective data can be collected simultaneously and automatically populated on an electronic mapping system that is both accurate and time effective.

In FIG. 3, a schematic diagram of an illuminance mapping system 300 is depicted. Illuminance mapping system 300 includes apparatus 100 and a separate (e.g., handheld) control device 104. Apparatus 100 includes, as described above, rod 102, base 106, and an optional accessory 108, such as an imaging device.

Control device 104 includes a processor 310, a memory 312, and display 114 configured to present a UI 316 to a user (e.g., user 200, shown in FIG. 1). Control device 104 may include any computing device, such as a smart phone, tablet, laptop, etc. In some embodiments, illuminance mapping system 300 includes more than one control device 104. Although control device 104 is depicted as separate from apparatus 100 (e.g., handheld by a user), in other embodiments, control device 104 is mounted to rod 102. For example, control device 104 may be mounted to dock 118 as shown in FIG. 1, and may be fixedly coupled to rod 102 or selectively removable from rod 102.

Control device 104 includes one or more control mechanisms 116. In one example embodiment, control mechanisms 116 are implemented as virtual user input controls displayed on display 114 of control device 104. For example, virtual control mechanisms 116 include interactive controls such as one or more buttons or icons. User 200 interacts with display 114 to operate virtual control mechanisms 116 and control the operational components of apparatus 100, including location sensor 122 and illuminance sensor 124. In one example embodiment, virtual control mechanism 116 includes, in part, a single control that, upon selection by user 200, causes generation and transmission of a control signal. The single control may be a discrete control associated with a particular displayed control mechanism 116 on display 114 (e.g., the virtual button with a “plus” sign, as shown in FIG. 3). In this way, control device 104 provides a simple interface for operation of apparatus 100 as described herein.

In another embodiment, control mechanisms 116 are implemented as physical control mechanisms separate from control device 104. For example, physical control mechanisms 116 may include one or more buttons, switches, levers on apparatus 100, such as integrated with dock 118. In such embodiments, user 200 operates one or more physical control mechanism(s) 116 to control the operational components of apparatus 100, including location sensor 122 and illuminance sensor 124. In one example embodiment, physical control mechanism 116 includes, in part, a single control that, upon manipulation by user 200, causes generation and transmission of a control signal. The single control may be single button, enabling simple operation of apparatus 100 as described herein.

In the example embodiment, imaging device 108 includes a 2D or 3D imaging device (e.g., camera) coupled to rod 102 at a top end thereof (e.g., top end 110, shown in FIG. 1). Imaging device 108 is operated simultaneously with location and illuminance sensors 122, 124, to capture on-site photometric conditions at the same time as the illuminance and location measurements are captured. It is contemplated that imaging device 108 may be located other than at the top end of rod 102. For example, in other embodiments, imaging device 108 may be separate from apparatus 100 and is remotely controlled via apparatus 100 (e.g., using control device 104). The image data captured by imaging device 108 facilitates improved visualization and localization of the illuminance and location measurements within an area of interest. For example, as discussed further herein, illuminance and location measurements can be mapped directly onto a 2D or 3D map of the area of interest generated in part using the captured image data, which enables measurements to be more readily understood, interpreted, and used by operators of illuminance mapping system 300.

Control device 104 is configured to execute an app through which user 200 may view data related to apparatus 100/system 300, such as, for example, location measurements, illuminance measurements, area of interest maps, and the like. In some such embodiments, control device 104 stores sensor data received from apparatus 100 in memory 312, or in an external database (not shown). Display 114 of control device 104 displays information to user 200, such as a status of apparatus 100, captured measurements from any sensor(s) of apparatus 100 (e.g., a location of apparatus 100, an illuminance captured at apparatus 100, etc.), a map of an area of interest, and the like. Specifically, in the example embodiment, display 114 is configured to receive and display location and/or illuminance measurements on UI 316. UI 316 may be, for example, a web page or app page displayed on display 114. For example, control device 104 is configured to execute GIS software thereon. The GIS software is configured to process measurements, such as location and illuminance measurements as well as image data captured at imaging device 108, and map measurements relative to the area of interest. As such, the GIS software enables enhanced output with improved visualization of illuminance maps, in real time. Using output from the executed GIS software, UI 316 may be generated using one or more of an ANDROID or iOS phone app or an AZURE web app. Moreover, UI 316 is configured to display measurements captured at apparatus 100 in real-time relative to the map of the area of interest.

Control device 104 is communicatively coupled to apparatus 100 via one or more communication networks 304, which may include a wired communication network (e.g., Ethernet, MODBUS, BACNET) and/or wireless communication network (e.g., a radio communication network, BLUETOOTH, ZIGBEE, LAN, cellular data network, Wi-Fi network, etc.).

Base 106 houses the operational components of apparatus 100, including location sensor 122 and illuminance sensor 124, as well as a power source 150, a processing unit 152 having a communication interface 154, and a memory 156.

In the example embodiment, processing unit 152 includes a communication interface 154 that enables wireless communication across one or more wireless communication networks 304, which may include a radio network such as BLUETOOTH or other NFC networks, a cellular data network, or a Wi-Fi data communication network. In one embodiment, processing unit 152 is embodied as an ESP32 unit. In some embodiments, processing unit 152 and memory 156 are combined as one processing device or computing device.

Location sensor 122 is a position and/or location sensor configured to capture position and/or location measurements (e.g., absolute coordinates, such as GPS coordinates, or coordinates/position values relative to a defined origin), with a measurement accuracy of two feet or less, including one foot or less, six inches or less, three inches or less, or two inches or less. In some embodiments, location sensor 122 is embodied as a GPS receiver 360 in combination with a GPS antenna 362, which may be co-located (e.g., within base 106) or located elsewhere on apparatus 100 (e.g., within rod 102 or optional accessory 108). In one embodiment, location sensor 122 is at least partially embodied as a ZED-F9N sensor, which has an accuracy of about 4 centimeters (cm). Location sensor 122 transmits location measurements to processing unit 152 for communication to control device 104 for display.

Illuminance sensor 124 is a sensor configured to capture illuminance readings, for example, in units of Lux. In the example embodiment, illuminance sensor 124 is embodied as a VEML7700 sensor. Alternatively, any suitable illuminance sensor may be used.

In the example embodiment, power source 150 includes a DC power source in the form of a battery, which provides power to the other components within base 106. It should be readily understood that power source 150 may include one battery, more than one battery, a battery pack, and the like, without departing from the scope of the present disclosure. Power source 150 may be of any size, capacity, and/or number that is suitable to operate the components of apparatus 100 as described herein. Although not shown, wiring for providing power to any components of apparatus 100 may be contained within base 106 and/or rod 102, as necessary, and such wiring may be permanent and/or removable. In some embodiments, housing 120 includes a removable battery cover (not shown), which may be removed to expose a battery enclosure (not shown). A user may insert the battery/batteries into and/or remove the battery/batteries from the battery enclosure and may replace the removable battery cover. The battery cover may be defined, for example, in side wall 126, bottom wall 128, or top wall 130 of housing 120. In other embodiments, power source 150 may be rechargeable, and housing 120 may therefore not include a removable battery cover. Housing 120 may include a charging port (e.g., to enable wired charging of one or more batteries) and/or an inductive coil therein (e.g., to enable wireless charging of the one or more batteries) (neither shown).

In operation, user 200 engages system 300 to simultaneously capture sensed position and illuminance measurements as well as image data within an area of interest. More specifically, user 200 operates control device 104 to generate a control signal, such as by operating or interacting with virtual control mechanisms 116 on display 114 (or physical control mechanisms 116 on control device 104 or rod 102). Control device 104 transmits the generated control signal to location sensor 122 and illuminance sensor 124, for example, over communication network 304. The control signal is also transmitted to imaging device 108. In some embodiments, processing unit 152 receives the control signal and, in response, automatically activates location sensor 122, illuminance sensor 124, and imaging device 108 to capture sensed data.

Upon activation, location sensor 122 captures a location measurement as a sensed location value (e.g., absolute coordinates, location relative to an origin point, etc.), and illuminance sensor 124 captures an illuminance measurement as a sensed illuminance value (e.g., in units of Lux). Imaging device 108 captures at least one real-time image (e.g., a 2D or 3D image) of the area of interest at which the location and illuminance measurements are captured. In some embodiments, these sensed values and the corresponding image data are locally stored in memory 156. The sensed values and image data are transmitted (e.g., via communication interface 154) over wireless communication network 304 to control device 104, for display to user 200 at display 114, such as within UI 316 (e.g., within an app or web browser). In this way, the surveyor or any other user can receive a real-time illuminance map during the surveying process. The sensed values, image data, and/or resulting illuminance map may be stored at apparatus 100, control device 104, and/or in an external database. Moreover, this data is exportable in various formats such that the data can be transferred to other devices for subsequent use.

The embodiments disclosed herein enable simultaneous location and illuminance measurement within an area of interest, which facilitates improved light mapping accuracy. Additionally, as described herein, this improved functionality is also realized with improved operator safety and ergonomic health.

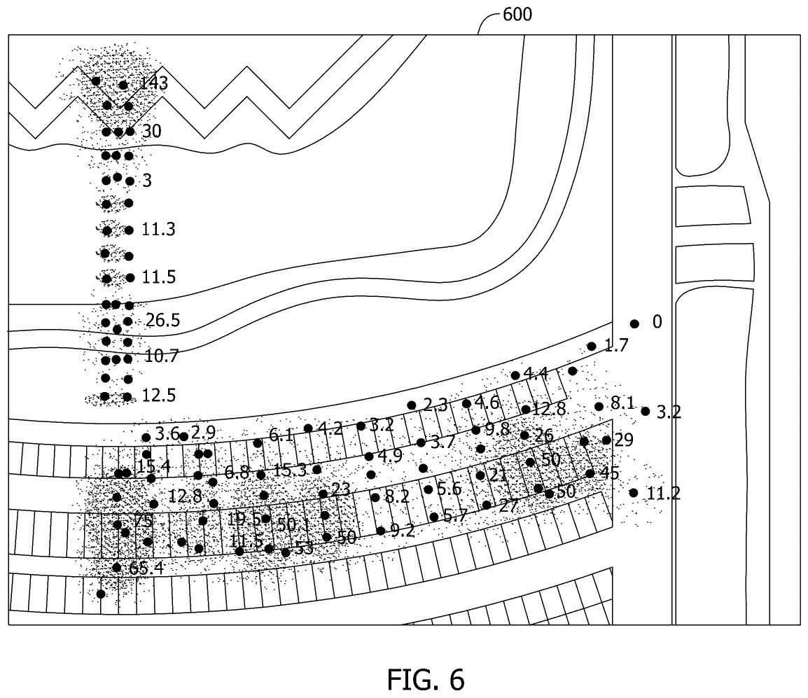

FIGS. 4-6 display example illuminance maps generated using apparatus 100 within illuminance mapping system 300. The area of interest includes, in these examples, a parking lot. The map 400 shown in FIG. 4 displays the locations at which illuminance measurements were captured using apparatus 100 as dots relative to the area of interest. The dots (or other icons or visual markers) may be color-coded according to the relative measured illuminance values. The map 500 shown in FIG. 5 displays the illuminance measurements as visualization of the relative Lux values captured using apparatus 100. Specifically, higher illuminance (higher Lux values) is displayed as brighter locations, offering an accurate and readily interpretable visualization of the light patterns within the parking lot. The map 600 shown in FIG. 6 displays a combination of maps 400, 500 along with numeric representations of the illuminance measurements (e.g., in units of Lux). Maps 400, 500, 600 are generated by processing and mapping data captured at apparatus 100. In some embodiments, maps 400, 500, and 600 are displayed at a remote computing device (not shown) in communication with control device 104, after processing and mapping the illuminance and location data.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

In the foregoing specification and the claims that follow, a number of terms are referenced that have the following meanings.

As used herein, an element or step recited in the singular and preceded with the word “a” or “an” should be understood as not excluding plural elements or steps, unless such exclusion is explicitly recited. Furthermore, references to “example implementation” or “one implementation” of the present disclosure are not intended to be interpreted as excluding the existence of additional implementations that also incorporate the recited features.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here, and throughout the specification and claims, range limitations may be combined or interchanged. Such ranges are identified and include all the sub-ranges contained therein unless context or language indicates otherwise.

Disjunctive language such as the phrase “at least one of X, Y, or Z,” unless specifically stated otherwise, is generally understood within the context as used to state that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

Some embodiments involve the use of one or more electronic processing or computing devices. As used herein, the terms “processor” and “computer” and related terms, e.g., “processing device,” “computing device,” and “controller” are not limited to just those integrated circuits referred to in the art as a computer, but broadly refers to a processor, a processing device, a controller, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processing (DSP) device, an application specific integrated circuit (ASIC), and other programmable circuits or processing devices capable of executing the functions described herein, and these terms are used interchangeably herein. The above embodiments are examples only, and thus are not intended to limit in any way the definition or meaning of the terms processor, processing device, and related terms.

In the embodiments described herein, memory may include, but is not limited to, a non-transitory computer-readable medium, such as flash memory, a random-access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROMs, DVDs, and any other digital source such as a network or the Internet, as well as yet to be developed digital means, with the sole exception being a transitory, propagating signal. Alternatively, a floppy disk, a compact disc-read only memory (CD-ROM), a magneto-optical disk (MOD), a digital versatile disc (DVD), or any other computer-based device implemented in any method or technology for short-term and long-term storage of information, such as, computer-readable instructions, data structures, program modules and sub-modules, or other data may also be used. Therefore, the methods described herein may be encoded as executable instructions, e.g., “software” and “firmware,” embodied in a non-transitory computer-readable medium. Further, as used herein, the terms “software” and “firmware” are interchangeable, and include any computer program stored in memory for execution by personal computers, workstations, clients and servers. Such instructions, when executed by a processor, cause the processor to perform at least a portion of the methods described herein.

Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

The systems and methods described herein are not limited to the specific embodiments described herein, but rather, components of the systems and/or steps of the methods may be utilized independently and separately from other components and/or steps described herein.

This written description uses examples to illustrate the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An apparatus for location-based illuminance sensing and recording, the apparatus comprising:
a rod having a first, top end, a second, bottom end, and a body extending between the first end and the second end; and
a base coupled to the second, bottom end of the rod, the base comprising a housing retaining a location sensor and an illuminance sensor configured to locally capture location measurements and illuminance measurements, respectively.

2. The apparatus of claim 1, wherein the housing further retains a power source and wireless communication interface therein.

3. The apparatus of claim 2, wherein the wireless communication interface comprises a radio communication interface.

4. The apparatus of claim 1, wherein, in response to a control signal from a control device communicatively coupled to the apparatus, the location sensor and the illuminance sensor capture respective sensed values.

5. The apparatus of claim 4, wherein the housing further retains a wireless communication interface therein, the wireless communication interface communicatively coupled to the location sensor and the illuminance sensor, wherein the wireless communication interface is configured to (i) receive the control signal from the control device and (ii) transmit the sensed values to the control device.

6. The apparatus of claim 4, wherein the housing further retains a memory device therein, the memory device communicatively coupled to the location sensor and the illuminance sensor, and wherein the memory device is configured to store the sensed values.

7. The apparatus of claim 1, further comprising at least one physical control mechanism, including one of a button, lever, or switch, operable by a user to generate the control signal.

8. The apparatus of claim 1, further comprising a dock coupled to the rod at an intermediate location along the body of the rod, wherein the dock is configured to retain a control device.

9. The apparatus of claim 8, wherein the intermediate location of the dock is at a height of between 24 inches to 48 inches.

10. The apparatus of claim 1, wherein the base is removably coupled to the rod.

11. The apparatus of claim 1, wherein the rod is collapsible.

12. The apparatus of claim 1, wherein the location sensor comprises a GPS receiver.

13. The apparatus of claim 12, wherein the apparatus further comprises a GPS antenna.

14. The apparatus of claim 1, further comprising an imaging device coupled to the first, top end of the rod.

15. The apparatus of claim 14, wherein the imaging device comprises a 360° camera.

16. An illuminance mapping system comprising:
an apparatus for location-based illuminance sensing and recording, the apparatus comprising:
a rod having a first, top end, a second, bottom end, and a body extending between the first end and the second end; and
a base coupled to the second, bottom end of the rod, the base comprising a housing retaining a location sensor and an illuminance sensor configured to locally capture location measurements and illuminance measurements, respectively; and
a control device communicatively coupled to the apparatus and configured to activate the illuminance sensor and the location sensor.

17. The illuminance mapping system of claim 16, wherein the control device is configured to transmit a control signal to the illuminance sensor and the location sensor to capture illuminance measurements and location measurements, respectively.

18. The illuminance mapping system of claim 16, wherein the control device comprises a display configured to display the location measurements and illuminance measurements to a user of the control device.

19. The illuminance mapping system of claim 16, wherein the control device is wirelessly communicatively coupled to the apparatus.

20. A method of location-based illuminance sensing, the method comprising:
providing an apparatus for location-based illuminance sensing and recording, the apparatus including: (i) a rod having a first, top end, a second, bottom end, and a body extending between the first end and the second end, and (ii) a base coupled to the second, bottom end of the rod, the base including a housing retaining a location sensor and an illuminance sensor configured to locally capture location measurements and illuminance measurements, respectively; and
operating a control device communicatively coupled to the apparatus to generate a control signal that causes the location sensor and the illuminance sensor to capture respective sensed values.
